(19) United States
(12) Patent Application Publication
(10) Pub. No.: US 2010/0110220 A1
(43) Pub. Date: May 6, 2010

(54) Systems and Methods for High-Throughput Turbidity Measurements

(75) Inventors: Mary Anne Leugers, Midland, MI (US); Tzu-Chi Kuo, Midland, MI (US); Jodi Milhaupt Mecca, Midland, MI (US); Carol Elaine Mohler, Midland, MI (US)

Correspondence Address: The Dow Chemical Company, Intellectual Property Section, P.O. Box 1967, Midland, MI, 48641-1967, US

(73) Assignee: DOW GLOBAL TECHNOLOGIES INC., Midland, MI (US)

(21) Appl. No.: 12/615,093

(22) Filed: Nov. 9, 2009

Related U.S. Application Data
(63) Continuation-in-part of application No. PCT/US2008/059575, filed on Apr. 7, 2008.
(60) Provisional application No. 60/916,878, filed on May 9, 2007.

(51) Int. Cl. G06K 9/00; G01N 21/59; H04N 5/222

(52) U.S. Cl. 348/222.1; 356/436; 382/100; 348/E05.022

(57) ABSTRACT

A turbidity measurement system includes a sample assembly that contains a plurality of samples, a light source that illuminates the sample assembly, and a light detection system that includes a two-dimensional light-sensitive array. The light-sensitive array is simultaneously exposed to light transmitted through each of the samples in the sample assembly. The exposure is analyzed to determine a mean transmitted light intensity for each sample and to calculate a turbidity value for each sample based on its mean transmitted light intensity. Multiple exposures may be taken during a measurement period so as to obtain time-resolved turbidity measurements of the samples. The temperature of the samples may be varied during the measurement period so as to measure turbidity as a function of temperature.

### CROSS-REFERENCE TO RELATED APPLICATIONS

This application is a continuation-in-part of International Patent Application No. PCT/US2008/059575, filed Apr. 7, 2008, which claims the benefit of U.S. Provisional Patent Application No. 60/916,878, filed May 9, 2007. The foregoing applications are incorporated herein by reference.

### BACKGROUND

1. Field of the Invention

The present invention relates to systems and methods for determining at least one parameter in each of a plurality of samples that are illuminated by a light source, for example, to facilitate high-throughput turbidity measurements.

2. Description of Related Art

Turbidimetry is the measurement of decreased intensity of incident light that is caused by scattering in an inhomogeneous system. The scattering could be caused, for example, by solid particles suspended in a liquid or by a mixture of different liquid phases that have different indices of refraction.

The “turbidity” of the inhomogeneous system is a value that can be related to the intensities of the incident and transmitted light (assuming there is no absorption of the light) by the following expression:

I=I₀e^{-τL} (1)

where I₀ is the intensity of the incident light, I is the intensity of the transmitted light, τ is the turbidity, and L is the optical path length, i.e., the distance through the sample that the light traverses. See Kirk-Othmer Encyclopedia of Chemical Technology, vol. 20, pp. 738-739 (2^{nd} ed. 1969).

Turbidimetry has been used in a wide range of applications. For example, turbidimetry has been in water quality studies to determine how much particulate matter is suspended in water samples.

Temperature-dependent turbidimetry has been used to study the properties of polymers, such as molecular weight distributions. In a typical experiment, a polymer sample is dissolved in a solution at a near precipitating condition, and then the temperature is lowered so that the polymer begins to precipitate out of solution. As precipitation occurs, the turbidity increases due to the formation of solid particles. Thus, the precipitation process can be monitored optically by monitoring the turbidity of the solution. The turbidity can be determined by measuring the intensity of the light transmitted through the solution. The instrumentation for such temperature-dependent turbidity measurements typically includes a light source, a temperature-controlled test cell, and a light sensor. See Manfred J. R. Cantow, ed., Polymer Fractionation, pp. 191-211 (Academic Press, 1967).

In practice, however, this type of experiment can be substantially time consuming. For example, one run of turbidity measurements to monitor the precipitation of a semi-crystalline polymer from a solution cooled from 160° C. to 30° C. may take two to five hours, because of the requirement of well-controlled cooling.

Accordingly, there is a need for providing more time-efficient methods and systems for obtaining turbidity measurements.

### SUMMARY

In a first principal aspect, an exemplary embodiment provides a system comprising a sample assembly, a light source, a light detection system, and a data analysis system. The sample assembly comprises a plurality of distinct locations for receiving samples and blanks. The light detection system is arranged to obtain an exposure of the sample assembly, such that the exposure includes light from the light source transmitted through each of the distinct locations. The data analysis system is configured to analyze the exposure to determine at least one parameter for each sample.

In a second principal aspect, an exemplary embodiment provides a system comprising: a plurality of samples; means for changing temperature of the samples; a light source arranged to transmit light through the samples, wherein the light traverses a respective optical path length through each sample; a digital camera having a field of view that encompasses the samples, the digital camera being operable to obtain a plurality of digital images of the field of view during a measurement period; a temperature controller for controlling the means for changing temperature of the samples so as to apply a temperature ramp to the samples during the measurement period; and a data analysis system configured to analyze the digital images to determine at least one temperature-dependent parameter for each of the samples.

In a third principal aspect, an exemplary embodiment provides a turbidity measurement method. In accordance with the method, light is transmitted through a plurality of samples and a plurality of blanks, wherein light traverses a respective optical path length through each sample and each blank. An exposure is obtained that includes light transmitted through each of the samples and each of the blanks. The exposure is analyzed to determine transmitted light intensities for the samples and the blanks A turbidity value is calculated for each of the samples based on a respective transmitted light intensity and optical path length.

### BRIEF DESCRIPTION OF THE DRAWINGS

FIG. 1 is a schematic diagram of a turbidity measurement system, in accordance with an exemplary embodiment.

FIG. 2 is a flow chart of a method for analyzing a digital image to determine sample turbidities, in accordance with an exemplary embodiment.

FIG. 3 is a digital image of a sample assembly containing a plurality of samples and a plurality of blanks, in accordance with an exemplary embodiment.

FIG. 4 shows plots of the variation of turbidity over time in a temperature-scanning experiment for a plurality of samples and a plurality of blanks contained in a sample assembly, in accordance with an exemplary embodiment.

### DETAILED DESCRIPTION OF EXEMPLARY EMBODIMENTS

### 1. Overview

To facilitate turbidity measurements of a plurality of samples in a high-throughput manner, a light source may be arranged to illuminate all of the samples in a sample assembly, and a light detection system may be arranged to obtain an exposure that includes light from the light source transmitted through each of the samples. The sample assembly may include a plurality of distinct locations for receiving samples. For example, the sample assembly may include a plurality of containers, such as wells, vials, or cuvettes. The containers may be arranged in an array and may be optically transparent.

The light source may be configured to uniformly illuminate one side of the sample assembly. For example, the light source might include a diffuse light panel. A light detection system, such as a digital camera, may be arranged on the other side of the sample assembly so that its field of view encompasses all of the samples in the sample assembly. While the sample assembly is being uniformly illuminated by the light source, the light detection system may obtain an exposure that includes light transmitted through each sample in the sample assembly. In this way, measurements of a plurality of samples may be performed simultaneously. In addition, the sample assembly may contain a plurality of blanks, so that samples and blanks can be measured simultaneously.

The exposure may then be analyzed to determine the intensities of the light transmitted through each of the samples, and turbidity values may be calculated for each of the samples based on the transmitted light intensities. For example, the exposure may be represented by a digital image that is made up of a plurality of pixels. Light from each sample may correspond to a distinct set of pixels in the digital image, such that the value of each of the pixels in the set may be related to the intensity of light transmitted through a particular part of the sample. Thus, for each sample or sample location, a set of pixels may be identified in the digital image as a region of interest (ROI). The pixels in the ROI may then be used to calculate a mean transmitted light intensity for the sample. Mean transmitted light intensities for any blanks contained in the array could be calculated in the same way. The mean transmitted light intensities for the blanks may be used to normalize the mean transmitted light intensities for the samples. A turbidity value for a sample may then calculated based on (i) the sample's normalized mean transmitted light intensity and (ii) an optical path length of the light transmitted through the sample. Alternatively or additionally, transmitted light intensities may be calculated in a plurality of ROIs for a sample to obtain a plurality of location-dependent transmitted light intensities. The location-dependent transmitted light intensities may then be used to calculate one or more measures of turbidity variation within the sample, such as a turbidity gradient.

In addition to turbidity, the system could be used to determine other parameters in the samples. For example, phases boundaries may be identified in a sample based on different regions of the sample having different transmitted light intensities. The exposure may then be analyzed to determine characteristic dimensions of one or more phases in a sample. In an exemplary application, a sample may develop a foam that can be identified as having a lower transmitted light intensity than the rest of the sample. The exposure may then be analyzed to determine the height of the foam. In addition to turbidity and dimensional parameters, other parameters of the samples could also be determined based on transmitted light intensities.

For certain applications, it may be beneficial to conduct time-resolved measurements parameters, such as sample turbidities. Examples where time-resolved turbidity measurements may be useful include, but are not limited to, studies of solubility, kinetics, environmental stability of formulations, cloud points, re-cystallization, solvent systems, formation of coacervates, emulsion stability, material releases, phase separations, gelation, miscibility, chemical reactions, gravitational settling, phase diagrams, foam stability, degradation, fluorescence, photoluminescence, titrations, and stability of turbid or colored solutions.

To perform time-resolved measurements, the light detection system may take multiple exposures of the sample assembly during a measurement period, and each exposure may be analyzed to calculate sample parameters. In this way, time-dependent variations in the turbidities, turbidity gradients, or other parameters may be determined for a plurality of samples.

Such time-resolved measurements may also involve the variation of one or more conditions, such as temperature, during the measurement period. This can be useful, for example, to study sample parameters as a function of temperature. To vary the temperature of the samples during the measurement period, the system may include means for changing temperature of the samples. Such means may include one or more heating devices and/or one or more cooling devices, under the control of a temperature controller.

The heating devices could include, for example, one or more resistive heaters (such as heating coils or heating cartridges) mounted in the sample assembly or otherwise in thermal contact with the samples. In other cases, heating devices may direct heat-transfer fluids to the sample assembly or may heat the samples radiatively, for example, using an infrared lamp or microwaves.

Cooling may be provided by ambient cooling, which may be aided by one or more fans for increased air flow. Cooling may also be provided by liquids, such as by using heat-transfer fluids, cooling baths, cooling jackets, and/or cryogenic fluids (e.g., liquid nitrogen or liquid helium). Alternatively, cooling devices, such as thermoelectric cooling devices (e.g., Peltier coolers), may be mounted in the sample assembly or otherwise in thermal contact with the samples.

The means for changing temperature of the samples could also be implemented as a temperature-controlled chamber that houses the samples. For example, the temperature-controlled chamber could be an oven for heating the samples. A temperature-controlled chamber could also be used to cool the samples.

The temperature controller may control the means for changing temperature of the samples so as to apply a temperature ramp to the samples during the measurement period. The temperature ramp could be either a heating ramp that increases the temperature during the measurement period or a cooling ramp that decreases the temperature during the measurement period. The temperature controller may measure the temperature of the sample assembly and may control heating and/or cooling devices based on the measured temperature (e.g., using PID control or other control algorithm). The temperature controller may measure the temperature of the sample assembly via one or more temperature sensors, such as thermocouples, placed at various locations in the sample assembly. Alternatively, indirect temperature sensors, such as infrared sensors, may be used.

In some cases, the temperature of the samples might not be actively controlled during the measurement period. For example, the samples could be heated to a temperature above an ambient temperature, followed by ambient cooling during the measurement period, or the samples could be cooled to a temperature below an ambient temperature, followed by ambient warming during the measurement period.

The samples may also be agitated during the measurement period. The agitation may be provided by shaking, stirring, or in some other manner. In an exemplary embodiment, the sample assembly is operatively coupled to a shaker that shakes the samples in a controlled manner. The shaking may occur either continually or intermittently during the measurement period. In one approach, the shaker may be configured to shake the sample assembly parallel to its optical axis, i.e., the direction in which light from the light source is transmitted through the sample assembly. That way, the light detection system can obtain exposures of the samples while the samples are being shaken. Alternatively, the shaker may be configured to provide a rotating or wrist-action type of shaking.

Instead of obtaining an exposure of the samples while the samples are being shaken, the samples could be shaken before an exposure is obtained. For example, the samples could be shaken for a shaking period that is completed before the exposure is obtained. The shaking period could range, for example, from about one minute to about one hour. The shaking period could be followed by a resting period (e.g., to allow bubbles to be released) before the exposure is obtained. The resting period could range from zero to 10 minutes, depending on the characteristics of the sample (such as viscosity).

The various components used for measurement may be centrally controlled, for example, by an appropriately programmed computer. Thus, a computer may be programmed to control the light detection system to obtain exposures at particular times during the measurement period and to control other components that operate during the measurement period (temperature controller, shaker, etc.). The computer could be a general-purpose computer, such as a desktop or laptop computer, or the computer could be part of an integrated turbidity measurement instrument.

The computer may also be programmed to perform data analysis on the exposures obtained by the light detection system. Thus, the computer may calculate mean light intensities, normalized mean light intensities, and turbidities of the samples based on the data contained in the exposures. The computer may also be communicatively coupled to one or more output devices, such as a display, plotter, and/or printer, that can provide a visual representation of the turbidity values calculated by the computer. For example, if sample turbidities are measured as a function of temperature, then the computer might programmed with the ability to display a plot of turbidity versus temperature for any selected sample.

By measuring a plurality of samples in a single exposure, measurements of sample parameters, such as turbidity, can beneficially be accomplished in a high-throughput manner. In addition, by controlling the temperature of a sample assembly containing a plurality of samples, high-throughput performance may also be achieved for temperature-dependent studies.

### 2. Exemplary Turbidity Measurement System

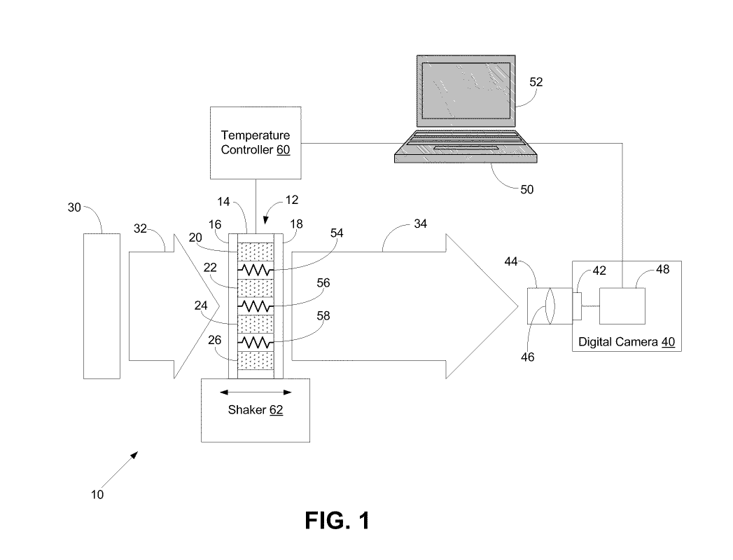

FIG. 1 illustrates an exemplary turbidity measurement system 10 that may be used for temperature-dependent turbidity studies. System 10 includes a sample assembly 12 that contains a plurality of samples and a plurality of blanks Sample assembly 12 could be configured in different ways. In the example illustrated in FIG. 1, sample assembly 12 includes a sample block 14, which has an array of distinct locations that can receive samples and blanks.

Sample block 14 is preferably made of a material with a high thermal conductivity, such as copper or aluminum, in order to provide good temperature uniformity. In particular, it is preferably to have a temperature variation of less than 0.1° C. throughout sample assembly 14. To achieve this level of temperature uniformity, sample block 14 may be constructed by taking a solid block of copper and drilling holes through it to define a desired sample array. The length of the holes through the block corresponds to the optical path length through the samples. An optical path length of about 1 cm may be used for many types of samples. However, the optical path length could be greater than 1 cm for samples that have a low turbidity, and the optical path length could be less than 1 cm for samples that have a high turbidity. For a given optical path length, the diameter of the holes may be used to define the sample volume (e.g., ranging from 300 to 500 microliters). In this approach, the samples and blanks may be placed directly in the holes in sample block 14. If the material of sample block 14 is reactive toward the samples or blanks, then sample block 14 may be coated with a non-reactive layer. For example, when sample block 14 is constructed from copper, a nickel coating has been found to work well with many types of samples.

Sample block 14 may be sealed with optically transparent windows 16 and 18 arranged on opposite sides thereof. Optically transparent windows 16 and 18 are made out of a material that is transparent to the wavelengths that are used to illuminate sample assembly 12. Thus, for visible light, windows 16 and 18 may be made out of glass. For ultraviolet light, windows 16 and 18 may be made out of quartz or sapphire. For near infrared wavelengths, a polytetrafluoroethylene material, such as TEFLON®, may be used for windows 16 and 18.

Windows 16 and 18 may be attached to sample block 14 in various ways. For example, windows 16 and 18 may be bolted onto sample block 14, with a gasket interposed between sample block 14 and each of windows 16 and 18. The gaskets may be used to seal the spaces around each of the holes in sample block 14. In this way, sample block 14 and windows 16 and 18 cooperatively define an array of optically transparent, sealed containers that can hold either samples or blanks.

It is to be understood, however, that an array of optically transparent, sealed containers could be constructed in other ways. For example, instead of placing samples and blacks directly into the holes in sample block 14, samples and blanks may be placed in individual transparent containers that are then placed in the holes in sample block 14. The containers could be, for example, standard-sized (1 to 2 mL), off-the-shelf glass vials that are sealed by crimp caps or screw caps. The use of standard-sized vials can beneficially facilitate the high-throughput processing of samples. For example, a robot may be used to place a large number of samples into individual vials, seal the vials, and then load the sealed vials into sample block 14 for turbidity measurement. When individually sealed vials are used as the containers in sample assembly 12, windows 16 and 18 may be omitted.

FIG. 1 shows four containers in sample assembly 12, i.e., containers 20, 22, 24, and 26, as being representative of an array of optically transparent containers. However, it is to be understood that the array of containers could be either one-dimensional or two-dimensional. Thus, sample assembly 12 in FIG. 1 might include a 4×4 array of containers, with only the four containers along one side being shown. Moreover, it is to be understood a sample assembly could include any number of containers. For example, a sample assembly with an 8×8 array of containers might be used. As another example, a sample assembly may include an 8×12 array of containers, i.e., as used in a standard 96-well microtiter plate.

Each container in sample assembly 12 may contain a sample, a blank, or may be left empty. A sample could be any material, whether solid, liquid, gaseous, or multi-phase, for which turbidity measurement is desired. Moreover, the plurality of samples contained in sample assembly 12 may all be the same type of sample or may include different types of samples.

A blank could be any material that can serve as a reference with respect to measurements made of one or more of the samples. For example, a sample might be a material, such as a polymer, that is dissolved in a solvent. In that case, a corresponding blank might be the solvent alone.

Blank-containing containers may be distributed among sample-containing containers in sample assembly 12. For example, the containers in the array may alternate between samples and blanks. With reference to FIG. 1, containers 20 and 24 may contain samples and containers 22 and 26 may contain blanks.

System 10 includes a light source 30 that illuminates sample assembly 12. in particular, light source 30 generates incident light 32 that enters sample assembly 12 through window 16. The light is transmitted through the samples and the blanks contained in sample assembly 12, so that transmitted light 34 emerges from sample assembly 12 through window 18. In an exemplary embodiment, light source 30 generates light in the visible portion of the spectrum. In other examples, however, incident light 32 and transmitted light 34 may include ultraviolet light and/or infrared light. In some cases, incident light 32 may include a wide range of wavelengths, e.g., if light source 30 is a “white light” source. Alternatively, incident light 32 could include a narrow range of wavelengths, e.g., if light source 30 is a narrowband source or is used with one or more filters.

Preferably, light source 30 illuminates sample assembly 12 uniformly, so that containers near the periphery of sample assembly 12, e.g., containers 16 and 26, are exposed to light with the same or nearly the same intensity as containers in the middle of sample assembly 12, e.g., containers 22 and 24. To achieve such uniformity, light source 30 may include a diffuse light panel that provides a beam of incident light 32 that covers the entire width of sample assembly 12.

An example of a uniform light source that has been found to work well is a backlight with an 8″×8″ white acrylic diffuser plate (part no. A08927 from Schott North America, Inc., Elmsford, N.Y.) that is illuminated by a DCR® III halogen lamp (part no. A20810 from Schott North America, Inc., Elmsford, N.Y.) via a fiber bundle. For best performance, the light output of the halogen lamp was stabilized using an EQUALIZER™ light feedback module that included a reference MODULAMP® unit (part no. A20670 from Schott North America, Inc., Elmsford, N.Y.).

A uniform light source 30 could also be provided in other ways, for example, using a fluorescent bulb with a diffuser, or by using LEDs, lasers, or fiber optically coupled sources.

Light source 30 could illuminate sample assembly 12 directly, as illustrated in FIG. 1. Alternatively, light source 30 could illuminate sample assembly 12 indirectly, via one or more optical components, such as mirrors, prisms, or lenses.

System 10 also includes a light detection system that detects transmitted light 34, i.e., the light transmitted along the optical axis through the samples and blanks in sample assembly 12. In the example illustrated in FIG. 1, the light detection system is provided as a digital camera 40 that includes a two-dimensional light-sensitive array 42. Light-sensitive array 42 could be, for example, a charge-coupled device (CCD), charge-injection device (CID), active pixel sensor, or other such device. An example of a CCD camera that has been found to work well is the QICAM™ fast 12-bit mono camera, available from QImaging Corporation, Burnaby, British Columbia, Canada. Alternatively, light-sensitive array 42 may comprise an array of discrete light sensors, such as photodiodes, with each discrete light sensor coupled to an individual optical fiber.

In addition, an imaging system 44 may be used to image sample assembly 12 onto light-sensitive array 42. In the example illustrated in FIG. 1, imaging system 44 includes a long focal length lens 46. However, it is to be understood that imaging system 44 could include other components.

Preferably, the focal length of imaging system 44 is long enough to image all of sample assembly 12 onto array 42, without vignetting. For example, a Nikon® zoom lens (AF Nikkor 28-85 mm) has been found to work well with the QICAM™ CCD camera identified above.

Digital camera 40 may include a controller 48 that controls the operation of light-sensitive array 42. In particular, controller 48 may determine when array 42 obtains exposures. For example, controller 48 may control 42 to take exposures with a specified exposure time at a specified frame rate. In addition, controller 48 and may read out completed exposures as digital images. Controller 48 may then store digital images in a memory, e.g., a memory internal to digital camera 40 or in a removable memory module, such as a memory card or memory stick.

Alternatively or additionally, controller 48 may be communicatively coupled to one or more external devices, such as a computer 50. Computer 50 may be programmed to control the operation of digital camera 40, e.g., by specifying an exposure time and/or frame rate at which digital camera 40 is to take exposures during a measurement period. Computer 50 and may also download digital images from digital camera 40, either during the measurement period while exposures are being taken or after the completion of the measurement period. Further, computer 50 may be programmed to analyze the digital images, as described in more detail below.

In an exemplary embodiment, imaging system 44 provides digital camera 40 with a field of view that encompasses all of sample assembly 12. That way, light-sensitive array 42 may be able to sense, in a single exposure, light transmitted through each of the containers in sample assembly 12. Moreover, when the exposure is represented as a digital image, each container may correspond to a distinct set of pixels in the digital image. Each pixel represents light transmitted through a particular part of a sample or blank. The number of pixels in each set could be hundreds or thousands, depending on such factors as the size of the containers in the sample array, how much of the field of view is occupied by the sample array, and the resolution of the light-sensitive array.

For purposes of analysis, however, only a subset of the pixels in each set might be used. For example, in order to reduce possible effects caused by the walls of the containers, only the pixels corresponding to the interior of each container (i.e., away from the walls) in each set of pixels might be used. Thus, computer 50 may be programmed to identify at least one region of interest (ROI) among the interior pixels for each sample-containing container and for each blank-containing container. Computer 50 may then calculate mean transmitted light intensities for each ROI in order to calculate sample turbidities and/or turbidity gradients, as described in more detail below.

Computer 50 may output the results of its calculations in various ways. For example, computer 50 may include a display 52 on which results are displayed in graphical or textual form. Alternatively, computer 50 may output results to one or more external devices, such as an external display, printer, plotter, and/or networked computers.

System 10 also includes means for temperature control of sample assembly 12 during the measurement period. In the example illustrated in FIG. 1, temperature control is provided by heating from resistive heaters (cartridge heaters from Watlow Electric Manufacturing Co., St. Louis, Mo.) in sample assembly 12, in combination with ambient cooling. To provide uniform heating of sample assembly 12, the resistive heaters may be placed between successive containers. Thus, FIG. 1 shows resistive heaters 54, 56, and 58 between containers 20, 22, 24, and 26.

A temperature controller 60 may be used to apply either a heating ramp or a cooling ramp. The temperature ramps may be anywhere in the range from room temperature (about 20° C.) up to about 200° C. However, these temperature ranges may be extended by the use of appropriate heating and/or cooling devices and by the use of samples and materials in sample assembly 12 that can withstand the temperatures.

To provide the desired temperature ramps, temperature controller 60 monitors the temperature of sample assembly 12, e.g., using J-type thermocouples, and controls the current through the resistive heaters, e.g., using PID control. Preferably, temperature controller 60 is able to control the temperature of sample assembly 12 to within ±0.2° C. To achieve this level of control, temperature controller 60 may be built from components available from Omega Engineering, Inc., Stamford, Conn.

Temperature controller 60 may, in turn, by controlled by computer 50. Thus, computer 50 may be programmed to provide temperature controller 60 with one or more temperature parameters, e.g., a set-point temperature or a temperature ramp rate, and temperature controller 60 may control the heating devices and/or cooling devices so as to achieve the specified temperature parameters. Further, computer 50 may control digital camera 40 to obtain a plurality of exposures of sample assembly 12 during the measurement period, while temperature controller 60 controls the temperature of sample assembly 12. In this way, system 10 can obtain measurements as a function of temperature.

System 10 may also include a shaker for shaking sample assembly 12 during the measurement period (either continually or intermittently). In the example illustrated in FIG. 1, sample assembly 12 is mounted on a shaker 62 that is configured to move sample assembly 12 back and forth in the direction indicated by the double-headed arrow. This shaking direction beneficially corresponds to the direction in light from light source 30 is transmitted through sample assembly 12. That way, shaking may occur at the same time that the digital camera is obtaining an exposure of sample assembly 12.

### 3. Exemplary Data Analysis Method

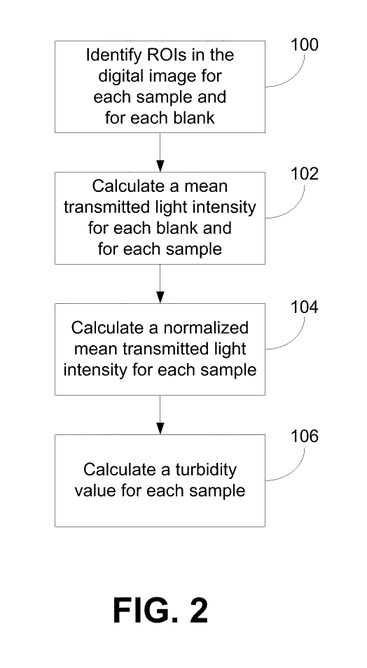

As noted above, computer 50 may be programmed to analyze digital images obtained by digital camera 40 in order to calculate one or more parameters (e.g, turbidity) of each sample in sample assembly 12. FIG. 2 is a flow chart that illustrates an exemplary method for analyzing a digital image.

The analysis process may begin by identifying ROIs in the digital image for each sample and each blank, as indicated by block 100. Each ROI may correspond to the pixels in the interior of the sample or blank, which may be a subset of (e.g., a third of) all the pixels that correspond to the sample or blank. In some cases, the pixels in each ROI may be identified in advance of obtaining the digital image. In other cases, the ROIs may be identified after the digital image is obtained. For example, computer 50 may identify a spot in the digital image as corresponding to a sample or blank and then identify a group of pixels in the middle of the spot as the ROI.

The ROIs may then be used to calculate a mean transmitted light intensity for each blank and for each sample, as indicated by block 102. In particular, the value of each pixel in the digital image may correspond to a particular light intensity. The relationship between pixel value and light intensity could be either linear or non-linear, for example, as determined in advance by calibration measurements. Given an appropriate calibration, the value of each pixel in an ROI for a sample or blank may be converted to a light intensity value. The light intensities for the pixels in the ROI may then be averaged together to obtain a mean transmitted light intensity for the sample or blank. In addition to the mean transmitted light intensity, a standard deviation of the light intensities represented by the pixels in the ROI could be calculated.

A normalized mean transmitted light intensity may then be calculated for each sample, as indicated by block 104. In particular, the mean transmitted light intensity for a sample may be normalized by the mean transmitted light intensity for a corresponding blank, which might be a blank that is located near the sample in sample assembly 12. Thus, a normalized mean transmitted light intensity, I_{N}, may be calculated as follows:

I_{N}=I_{S}/I_{B} (2)

where I_{S} is the mean transmitted light intensity of the sample and I_{B} is the mean transmitted light intensity of the blank.

The normalized mean transmitted light intensities may then be used to calculate a turbidity value for each sample, as indicated by block 106. The turbidity calculation may be based on expression (1), taking/as the mean transmitted light intensity of the sample (I_{S}) and I₀ as the mean transmitted light intensity of the blank (I_{B}). Combining expressions (1) and (2) leads to the following expression for calculating a turbidity value:

τ=−(1/L)log I_{N} (3)

where τ is the turbidity of the sample, L is the optical path length through the sample, and I_{N} is the normalized mean transmitted light intensity.

In addition, a plurality of ROIs could be identified in a sample and used to calculate a corresponding plurality of location-dependent turbidity values for the sample. The location-dependent turbidity values could then be used to calculate a turbidity gradient in the sample. Alternatively, the location-dependent turbidity values could be used to identify different phases in different regions of the sample, and the dimensions (such as height) of the different phases may be determined.

These calculations may be repeated for each sample that is imaged in the digital image. If multiple digital images are taken, then the calculations may be repeated for each sample in each digital image. In this way, variations in sample turbidities from image to image may be determined. For example, if the temperature of the samples changes from image to image, then the sample turbidities may be recorded as a function of temperature.

In addition, various parameters of interest may be calculated from the plots of turbidity versus temperature. For example, a first derivative of a turbidity versus temperature curve may be taken to determine the cloud point (or peak position of turbidity transition). Other quantities, such as peak areas, widths, or heights may also be determined.

By taking an average over multiple pixels in an ROI, a higher signal-to-noise ratio than for a single photodiode detector may be achieved, provided that the pixels in the ROI are not saturated. In this regard, it is preferable to take measurements under conditions that do not saturate any of the relevant pixels in the digital images. This can be achieved by appropriately adjusting such factors as the intensity of the light source, the exposure time, and the gain of the CCD or other detector.

### 4. Exemplary Temperature-dependent Turbidity Study

A system as illustrated in FIG. 1 and as described above was used to study to the solubility of semi-crystalline polyethylene (PE). More particularly, turbidity measurements were taken at various temperatures in order to study the temperature-dependence of the solubility of PE in a solvent, 1,2,4-trichlorobenzene (TCB). At high temperatures, the PE was completely dissolved in the solvent and the solution was clear, i.e., turbidity was low. As the temperature decreased, the PE began to crystallize out of the solvent, forming small particles that scattered light. Thus, as the temperature decreased, the turbidity of the samples increased.

In this study, an 8×8 multi-well sample assembly with integrated heating cartridges (resistive heaters) was used. Half of the wells were filled with samples, and half of the wells were filled with blanks, in an alternating fashion. Each sample was a volume of PE dissolved in TCB at 160° C., at a concentration of 1 mg/mL. Each blank was the same volume of TCB, but without any dissolved PE. The sample assembly was then sealed and placed on a shaker as illustrated in FIG. 1.

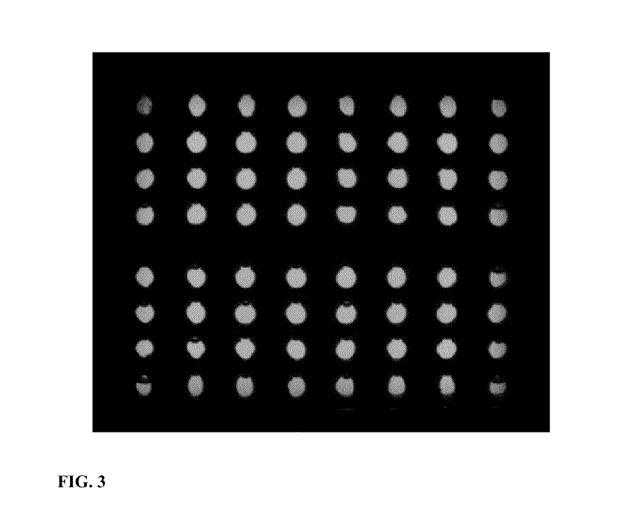

To ensure the complete dissolution of PE in TCB, the sample assembly was held at a temperature of 160° C. for two hours. Then, during the measurement period, the sample assembly was cooled from 160° C. to 30° C. in 90 minutes by a linear cooling ramp controlled by the temperature controller. During this measurement period, the light detection system (a CCD camera) took digital images of the sample assembly at a rate of 6 frames per minute. FIG. 3 is an example of a digital image obtained in this study. Each bright spot in the image represents either a sample or a blank in the sample assembly.

A computer program was then used to analyze the digital images. A ROI of about 200 to 350 pixels was identified for each sample and for each blank. A mean transmitted light intensity was calculated for each sample and for each blank, as described above. It was found that the wells along the edges of the multi-well assembly exhibited slightly lower light intensities than the other wells, apparently because of some non-uniformity in the incident light from the light panel that was used. For this reason, the wells along the edges were excluded from further calculations.

For the samples in the remaining wells, normalized light intensities were calculated. Turbidities for the samples were then calculated based on the normalized light intensities and the optical path length through the samples.

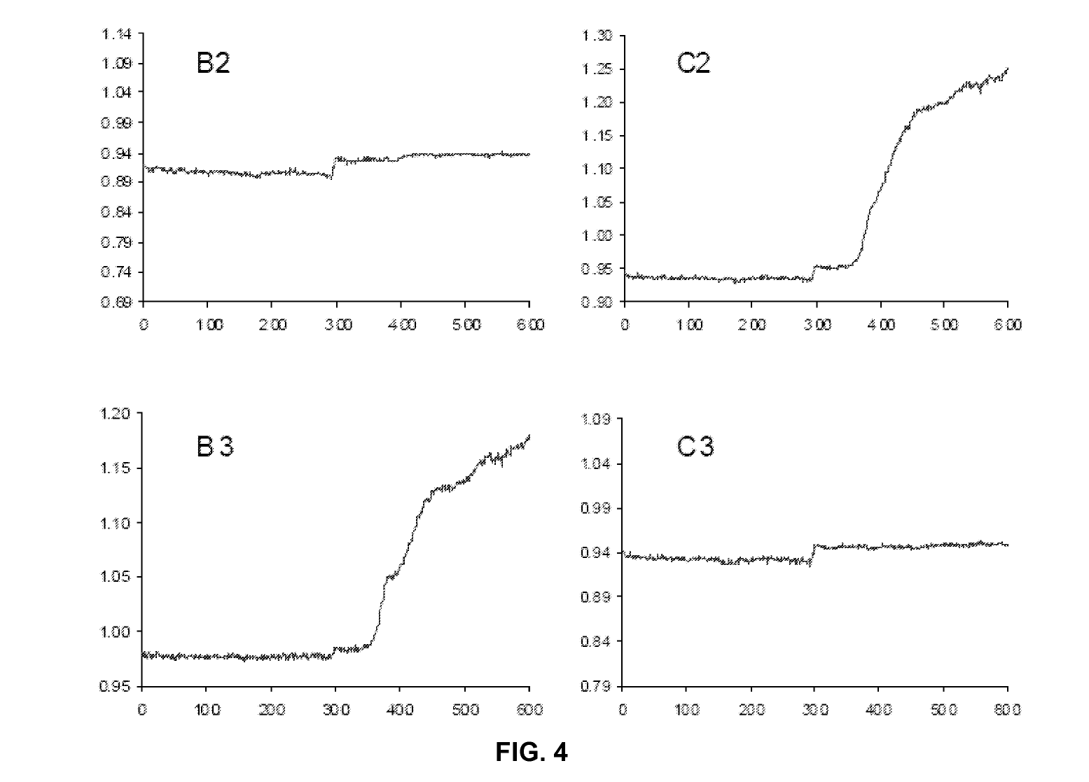

FIG. 4 include plots that show the variation of turbidity over time during the measurement period in this experiment. The plots for the blanks are essentially flat, as expected. The plots for the samples show an increase in turbidity during the latter part of the experiment, i.e., when the temperature had fallen to the point that the polymer began to re-crystallize, forming small particles that scattered the incident light.

This study also found that acceptable digital images of the sample assembly could be obtained when the sample assembly is shaken during the imaging, provided that the sample assembly is shaken along the optical axis. Specifically, the shaking motion showed no significant effect on the temperature-dependent turbidity results when the traveling distance of the shaking motion (about 2.5 cm) was relatively small compared to the distance between the CCD camera and the sample assembly (about 150 cm).

### 5. Conclusion

Exemplary Embodiments of the Present Invention have been Described Above. Those skilled in the art will understand, however, that changes and modifications may be made to these embodiments without departing from the true scope and spirit of the invention, which is defined by the claims.

What is claimed is:

1. A system, comprising:
a sample assembly, said sample assembly comprising a plurality of distinct locations for receiving samples and blanks;
a light source;
a light detection system arranged to obtain an exposure of said sample assembly, such that said exposure includes light from said light source transmitted through each of said distinct locations; and
a data analysis system configured to analyze said exposure to determine at least parameter for each sample.

2. The system of claim 1, wherein said light source comprises a diffuse light panel that illuminates all of said distinct locations simultaneously.

3. The system of claim 1, wherein said light detection system comprises a two-dimensional light-sensitive array.

4. The system of claim 1, wherein said at least one parameter includes a turbidity value.

5. The system of claim 1, wherein said at least one parameter includes a turbidity gradient.

6. The system of claim 1, further comprising:
a shaker for shaking said sample assembly in a shaking direction that corresponds to a direction in which light from said light source is transmitted through said sample assembly.

7. The system of claim 1, wherein said light detection system is configured to obtain a plurality of exposures of said sample assembly during a measurement period and said data analysis system is configured to determine said at least one parameter for each sample in each of said exposures.

8. A system, comprising:
a plurality of samples;
means for changing temperature of said samples;
a light source arranged to transmit light through said samples, wherein light traverses a respective optical path length through each sample;
a digital camera, said digital camera having a field of view that encompasses said samples, said digital camera being operable to obtain a plurality of digital images of said field of view during a measurement period;
a temperature controller for controlling said means for changing temperature of said samples so as to apply a temperature ramp to said samples during said measurement period; and
a data analysis system configured to analyze said digital images to determine at least one temperature-dependent parameter for each of said samples.

9. The system of claim 8, wherein said means for changing temperature of said samples comprises a plurality of resistive heaters in thermal contact with said samples via a block of thermally conductive material.

10. The system of claim 8, wherein said means for changing temperature of said samples comprises a temperature-controlled chamber housing said samples.

11. The system of claim 8, wherein said temperature ramp is a heating ramp.

12. The system of claim 8, wherein said temperature ramp is a cooling ramp.

13. A turbidity measurement method, comprising:
transmitting light through a plurality of samples and a plurality of blanks, wherein light traverses a respective optical path length through each sample and each blank;
obtaining an exposure that includes light transmitted through each of said samples and each of said blanks;
analyzing said exposure to determine transmitted light intensities for said samples and said blanks; and
calculating a turbidity value for each of said samples based on a respective transmitted light intensity and optical path length.

14. The method of claim 13, wherein transmitting light through a plurality of samples and a plurality of blanks comprises:
transmitting light through all of said samples and blanks simultaneously.

15. The method of claim 13, wherein obtaining an exposure that includes light transmitted through each of said samples and each of said blanks comprises:
obtaining a digital image of said samples and blanks, said digital image comprising a plurality of pixels.

16. The method of claim 15, wherein analyzing said exposure to determine transmitted light intensities for said samples and blanks comprises:
identifying for a sample at least one region of interest (ROI) in said plurality of pixels and calculating a mean transmitted light intensity in said at least one ROI.

17. The method of claim 16, wherein analyzing said exposure to determine transmitted light intensities for said samples and blanks comprises:
calculating transmitted light intensities in a plurality of ROIs in said sample to obtain a plurality of location-dependent transmitted light intensities; and
calculating a turbidity gradient in said sample based on said location-dependent transmitted light intensities.

18. The method of claim 13, further comprising:
obtaining a plurality of exposures during a measurement period, wherein each of said exposures includes light transmitted through each of said samples and each of said blanks.

19. The method of claim 18, further comprising:
applying a temperature ramp to said samples during said measurement period; and
calculating temperature-dependent turbidity values for each of said samples.

20. The method of claim 13, further comprising:
shaking said samples for a shaking period that is completed before said exposure is obtained.
